(19) United States
(12) Patent Application Publication
(10) Pub. No.: US 2016/0057614 A1
(43) Pub. Date: Feb. 25, 2016

(54) METHOD AND AN APPARATUS TO IDENTIFY A DEVICE

(71) Applicant: QUALCOMM Incorporated, San Diego, CA (US)

(72) Inventor: Alejandro Raul HOLCMAN, San Diego, CA (US)

(21) Appl. No.: 14/463,505

(22) Filed: Aug. 19, 2014

(51) Int. Cl. H04W 8/24; H04W 76/02; H04W 24/08

(52) U.S. Cl. CPC H04W 8/24; H04W 24/08; H04W 76/021

(57) ABSTRACT

A method, an apparatus, and a computer program product for wireless communication are provided. The apparatus may be a base station without connection to a core network. The base station establishes a wireless connection with a user equipment (UE). The base station receives a UE identifier that is specific to the UE.

### BACKGROUND

1. Field

The present disclosure relates generally to communication systems, and more particularly, to acquisition of mobile device identification information.

2. Background

A service station (e.g., a mobile device recycling kiosk) for a mobile device may provide various features with respect to user's mobile device. A user may provide the service station with information (e.g., mobile device identification information to identify the mobile device) about the mobile device. Based on the information about the mobile device, the service station may provide various features with regard to the mobile device. Thus, the user may utilize the service station to perform various tasks associated with the mobile device at the service station. For example, the user may sell a used mobile device at the service station and possibly obtain cash or a cash credit for the used mobile device at the service station based on the mobile device identification information. In order to utilize the service station for the mobile device, it may be desirable to establish a connection between the service station and the mobile device, such that the service station and the mobile device may communicate with each other via the connection. Therefore, an approach to conveniently perform communication between the service station and the mobile device has been developed.

### SUMMARY

In an aspect of the disclosure, a method, a computer program product, and an apparatus are provided. The apparatus may be a base station without connection to a core network. The base station establishes a wireless connection with a user equipment (UE). The base station receives a UE identifier that is specific to the UE.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a base station and user equipment in an access network.

FIG. 4 is an example kiosk that is capable of wireless communication with a UE, according to an aspect of the disclosure.

FIG. 5 is an example diagram of communication between a UE and a base station of a kiosk, according to an aspect of the disclosure.

FIG. 6 is a flow chart of a method of wireless communication.

FIG. 7 is a conceptual data flow diagram illustrating the data flow between different modules/means/components in an exemplary apparatus.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

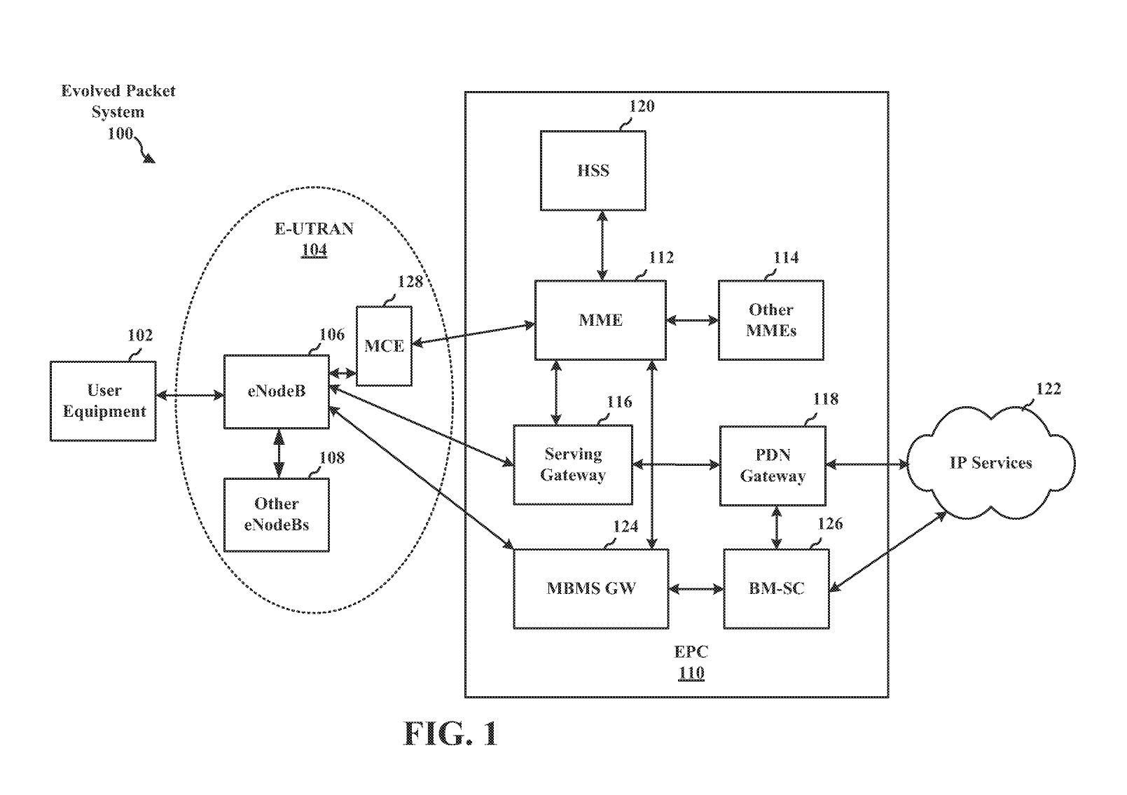

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

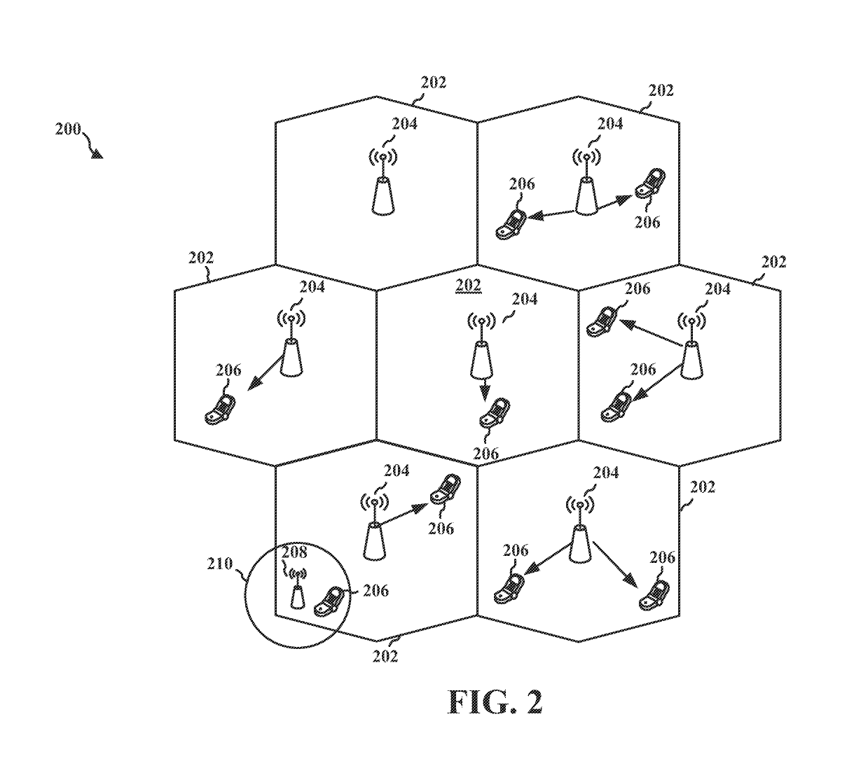

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving are particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

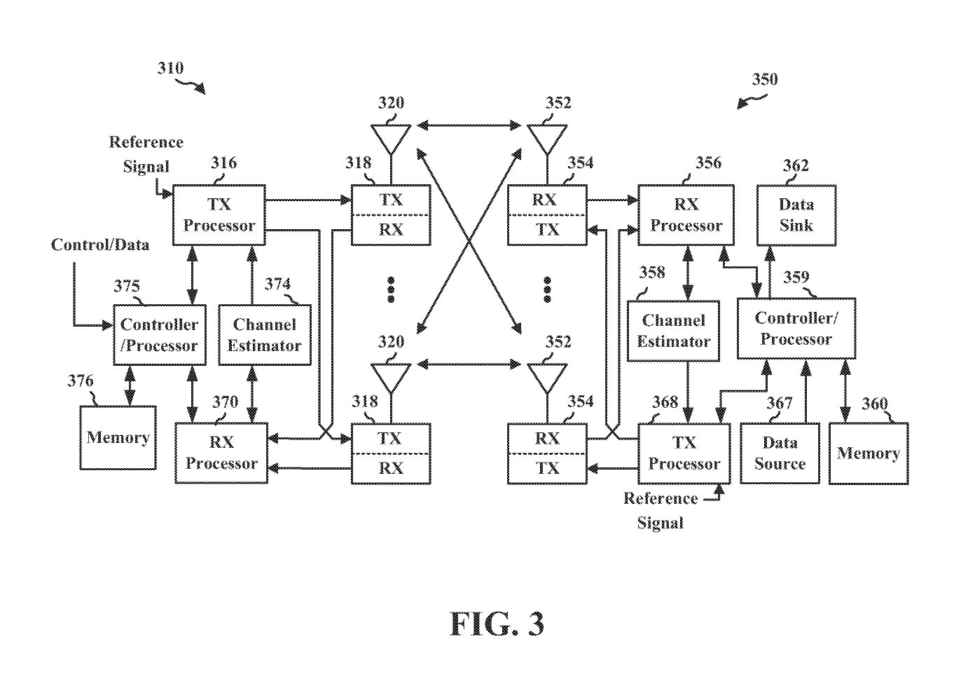

FIG. 3 is a block diagram of a base station 310 in communication with a UE 350 in an access network. The controller/processor 375 implements the functionality of a layer 2 (L2) layer. In the DL, the controller/processor 375 may provide header compression, ciphering, packet segmentation and reordering, multiplexing between logical and transport channels, and radio resource allocations to the UE 350 based on various priority metrics. The controller/processor 375 is also responsible for HARQ operations, retransmission of lost packets, and signaling to the UE 350.

The transmit (TX) processor 316 may implement various signal processing functions for a layer 1 (L1) layer (i.e., physical layer). The signal processing functions include coding and interleaving to facilitate forward error correction (FEC) at the UE 350 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The RX processor 356 implements various signal processing functions of the L1 layer. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359.

The controller/processor 359 implements the L2 layer. The controller/processor can be associated with a memory 360 that stores program codes and data. The memory 360 may be referred to as a computer-readable medium. In the UL, the controller/processor 359 provides demultiplexing between transport and logical channels, packet reassembly, deciphering, header decompression, control signal processing to recover upper layer packets from the core network. The upper layer packets are then provided to a data sink 362, which represents all the protocol layers above the L2 layer. Various control signals may also be provided to the data sink 362 for L3 processing. The controller/processor 359 is also responsible for error detection using an acknowledgement (ACK) and/or negative acknowledgement (NACK) protocol to support HARQ operations.

In the UL, a data source 367 is used to provide upper layer packets to the controller/processor 359. The data source 367 represents all protocol layers above the L2 layer. Similar to the functionality described in connection with the DL transmission by the base station 310, the controller/processor 359 implements the L2 layer for the user plane and the control plane by providing header compression, ciphering, packet segmentation and reordering, and multiplexing between logical and transport channels based on radio resource allocations by the base station 310. The controller/processor 359 is also responsible for HARQ operations, retransmission of lost packets, and signaling to the base station 310.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370. The RX processor 370 may implement the Ll layer.

The controller/processor 375 implements the L2 layer. The controller/processor 375 can be associated with a memory 376 that stores program codes and data. The memory 376 may be referred to as a computer-readable medium. In the UL, the control/processor 375 provides demultiplexing between transport and logical channels, packet reassembly, deciphering, header decompression, control signal processing to recover upper layer packets from the UE 350. Upper layer packets from the controller/processor 375 may be provided to the core network. The controller/processor 375 is also responsible for error detection using an ACK and/or NACK protocol to support HARQ operations.

With fast-developing mobile technology, users may frequently replace their mobile devices with new mobile devices with new technology. Therefore, a service station such as a kiosk has been developed to allow users to conveniently resell and/or recycle their (used) mobile devices. The service station may treat the mobile devices differently based on a type of the mobile device and/or conditions of the mobile device. For example, the service station may offer the user a different amount of cash based on a type of the mobile device. In another example, the service station may offer the user a different amount of cash if the service station determines that the mobile device is broken.

Because there are many different types of mobile devices, it is desirable to identify the mobile device that is connected to the service station. In one approach, a user may look up identification information (e.g., a serial number) in the mobile device, and manually enter the identification information in the service station, such that the service station may determine a type of the mobile device based on the identification information provided by the user. However, it may be inconvenient for the user to manually search for the identification information of the mobile device and to manually enter the identification information into the service station. In another approach, a service station may include one or more cables that may be connected to the user's mobile device, such that the service station may retrieve identity information of the mobile device and/or other information about the mobile device via the cable connection. However, it may be inconvenient for a user to manually connect the cable to the mobile device to enable communication between the mobile device and the service station. Further, if the mobile device's connection port to the cable is broken or is not compatible to a cable provided by the service station, the user may not be able to connect the mobile device to the cable of the service station. Therefore, a service station that can conveniently connect to a mobile device without much user intervention is desired.

According to the disclosure, a service station includes a base station that is configured to wirelessly communicate with a mobile device (e.g., a UE). Thus, the base station of the service station may wirelessly communicate with the UE in order to receive information related to the UE. The UE may communicate identification information of the UE and/or other information (e.g., a radio-frequency (RF) signature, transmission quality information of the UE, etc.) to the base station of the service station. According to the disclosure, the base station in the service station is not connected to a core network (e.g., the EPC 110), and thus may not provide a cellular service. In one example, the base station may be a lower power class base station (e.g., a femto cell) that does not have connection to a core network and is capable of communicating with a UE wirelessly. The femto cell of the service station may not provide a cellular service (e.g., without connection to the core network/macro network). It is noted that, because the identification information of the UE is communicated wirelessly to the base station of the service station, the service station does not need a cable to plug into the UE. Thus, the user can conveniently have the UE communicate with the base station of the service station via the wireless connection even if the UE does not have a proper connection port for a cable or does not have a working display screen to provide guidance for a cable connection.

In an aspect, the UE may actively send the identification information of the UE to the base station (e.g., via a push operation). In another aspect, the base station may retrieve the identification information from the UE (e.g., via a pull operation). For example, the pull operation may be useful if the user's UE is not fully functional (e.g., due to a broken display screen or broken buttons) such that the user cannot actively send information or a connection request using the UE or enter a user input. In such an example, even if the UE cannot initiate the connection with the base station, the base station may retrieve information from the UE via the pull operation.

Each UE is generally associated with identification information that is specific to the UE. Thus, for example, a model type and a manufacturer of the UE may be determined based on the identification information. The identification information of the UE may be an international mobile equipment identity (IMEI). The IMEI includes a set of numbers that is specific to a UE, and each UE has its own unique IMEI. The IMEI includes information about the UE, such as a manufacturer, a model type, etc. For example, the IMEI may include a set of numbers identifying a manufacturer and a model number, and a set of numbers specific to the UE. In one example, if the IMEI includes four sets of numbers in a format, aaaaaa-bb-cccccc, the first set of numbers (e.g., aaaaaa) may represent a country code, a model number, and an assembly code, the second set of numbers (e.g., bb) may represent a manufacturer, and the third set of numbers (e.g., cccccc) may represent a serial number of the UE.

The base station at the service station may receive the identification information (e.g., IMEI) of the UE via wireless communication, such that the base station of the service station may determine a type of the UE based on the identification information of the UE. In one example, the base station may have access to a database including identification information corresponding to respective UEs. Thus, the base station may determine a type of the UE based on the identification information of the UE and the information included in the database. For example, the base station may look up the identification information of the UE in the database and match the identification information of the UE with corresponding UE information in the database (e.g., to determine a manufacturer and a model type of the mobile device). According to an example database shown in Table 1, if the UE's identification information is 111111-12-222222, the base station may determine that the UE's manufacturer is Company B and the UE's model type is Tablet A by looking up 111111-12-222222 in the database. The database may be stored within the base station or may be stored outside the base station. The database may be updated (e.g., via an Internet connection), in order to provide a most up-to-date database.

TABLE 1
An example database of identification information of mobile devices

| Identification Information | Manufacturer | Model |
|---|---|---|
| 111111-11-111111 | Company A | Mobile Phone A |
| 111111-12-222222 | Company B | Tablet A |
| 111112-11-333333 | Company A | Mobile Phone B |

After determining the type of the UE, the base station of the service station may further determine the value of the UE based the type of the UE. For example, the base station may determine a higher value for a UE that is a more recent model, based on the type of the UE. Further, the base station may determine the value of the UE based on the condition of the UE. In particular, via the wireless connection established with the UE, the base station may perform various tests on the UE, to determine the condition of the UE. The base station may determine the value of the UE based on results of the tests performed on the UE. For example, if the base station determines that the UE fails at least one or more tests, the base station may decrease the value of the UE based on the failed test(s) because the failed test(s) may indicate that at least a part of the UE may be broken.

In an aspect, the base station at the service station may determine whether the UE is stolen or not, based on the identification information (e.g., IMEI) of the UE. For example, if a user reports (e.g., by reporting to a service provider) that the user's UE is stolen, then the identification information corresponding to the user's stolen UE may be placed on a black list. The base station may access the black list that lists identification information corresponding to stolen devices, to determine whether the UE is stolen or not. If the base station determines based on the black list that the UE communicating with the base station is stolen (e.g., the IMEI of the UE is listed in the black list), the base station may determine to refuse to provide a service to the stolen UE. Thus, the service station may not provide any features or may provide only limited features to a stolen UE based on the black list. It is noted that the black list may be maintained by a service provider. In one example, the base station may access the black list via an Internet connection.

In order to establish connection with the base station of the service station, the UE may send a connection request to the base station. Upon receiving the connection request from the UE, the base station may establish connection with the UE based on the connection request. In one aspect, the user may use the emergency call features of the UE to establish connection between the UE and the base station, and the base station may receive the identification information of the UE through the established connection. Many user devices have an emergency call feature which allows a user to make emergency calls, even without any subscriber identity module (SIM) card or subscription to a cellular service. Thus, even if the UE does not have a SIM card or subscription to a cellular service, the emergency call feature of the UE may be used to communicate with the base station of the service station.

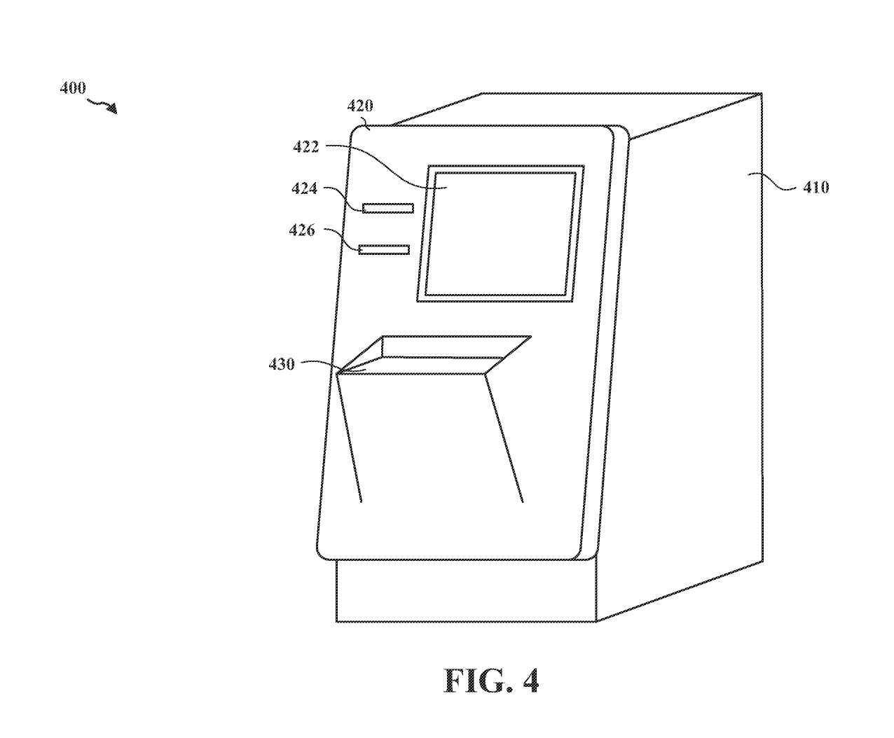

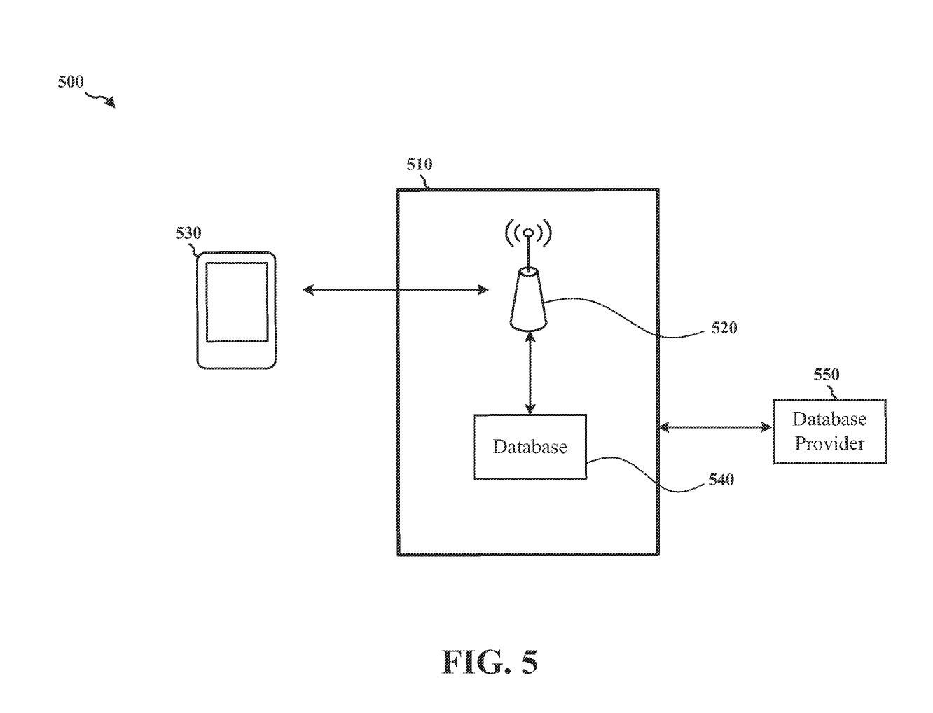

FIG. 4 is an example service station 400 that is capable of wireless communication with a UE, according to an aspect of the disclosure. The example service station 400 has a housing 410 and a front portion 420. The front portion 420 includes a display screen 422 to display information with regard to features provided by the service station 400. The front portion 420 may include a cash slot 424 to provide cash in exchange for the UE. The front portion 420 may include a card slot 426 to read a credit card and/or a cash card. In an aspect, the card slot 426 may be used to provide a cash credit to the credit card or the cash card in exchange for the UE. The front portion 420 may include a deposit platform 430 to place a UE for depositing the UE into the service station 400. The service station 400 includes a base station (not shown) to provide a wireless connection with a UE, as described in association with FIG. 5.

FIG. 5 is an example diagram 500 of communication between a UE and a base station of a service station, according to an aspect of the disclosure. A service station 510 may be equivalent to the service station 400 of FIG. 4. The service station 510 includes a base station 520 having no connection to a core network. In an aspect, the base station 520 may include a communication module configured to perform communication with a UE 530. The communication module of the base station 520 may receive a call processing message (e.g., a telephone call) from the UE 530 and process the call processing message, although the base station 520 has no connection to the core network. Thus, the communication module of the base station 520 enables the UE 530 to communicate with the base station 520 via a call processing message by the UE 530 to the base station 520. For example, the UE 530 may be used to place an emergency call to communicate with the base station 520. In another aspect, the base station 520 may be connected with a central network element that exists outside the service station 510, such that the central network element may process communication between the base station 520 and the UE 530. For example, when the UE 530 sends a communication (e.g., an emergency call or a registration message) to the base station 520, the base station 520 forwards the communication to the central network element. The central network element processes the communication from the UE 530, and may send a reply communication to the base station 520 based on the processed communication. Subsequently, the base station 520 forwards the reply communication to the UE 530. The central network element may communicate with the base station 520 via a TCP/IP connection and/or a local area network connection such as a WLAN connection or an Ethernet connection. The central network element may be connected to multiple base stations, and thus may provide a centralized processing of a message from a UE.

The base station 520 may establish a wireless connection with the UE 530 to receive identification information (e.g., IMEI) of the UE 530 from the UE 530 via the wireless connection. The base station 520 may establish the wireless connection with the UE 530 upon receiving a connection request from the UE 530. The base station 520 may receive the identification information from the UE 530 via a pull operation or via a push operation. The service station 510 may also include a database 540 of UE identification information and corresponding UEs. The database 540 may be updated via the database provider 550. The base station 520 performs identification of the UE 530 based on the received identification information. In an aspect, the base station 520 may perform identification of the UE 530 by looking up the received identification information in the database 540 and/or the database provider 550. Based on the identification of the UE 530, the base station 520 determines the value of the UE 530. The determined value of the UE 530 may be displayed on the display screen 422. If the user accepts the determined value of the UE 530, the user may select “YES” on the display screen 422 and deposit the UE 530 in the deposit platform 430. Subsequently, the service station 400 (or the service station 510) may provide cash (e.g., via the cash slot 424) or a cash credit (e.g., via the card slot 426) corresponding to the determined value of the UE 530. However, the base station 520 may determine that the UE 530 is a stolen device based on the identification information, if the identification information of the UE 530 is listed in a black list of stolen devices, for example. If the base station 520 determines that the UE 530 is a stolen device, the display screen 422 may display a message that the service station 400 (or the service station 510) cannot provide a service with regard to the UE 530.

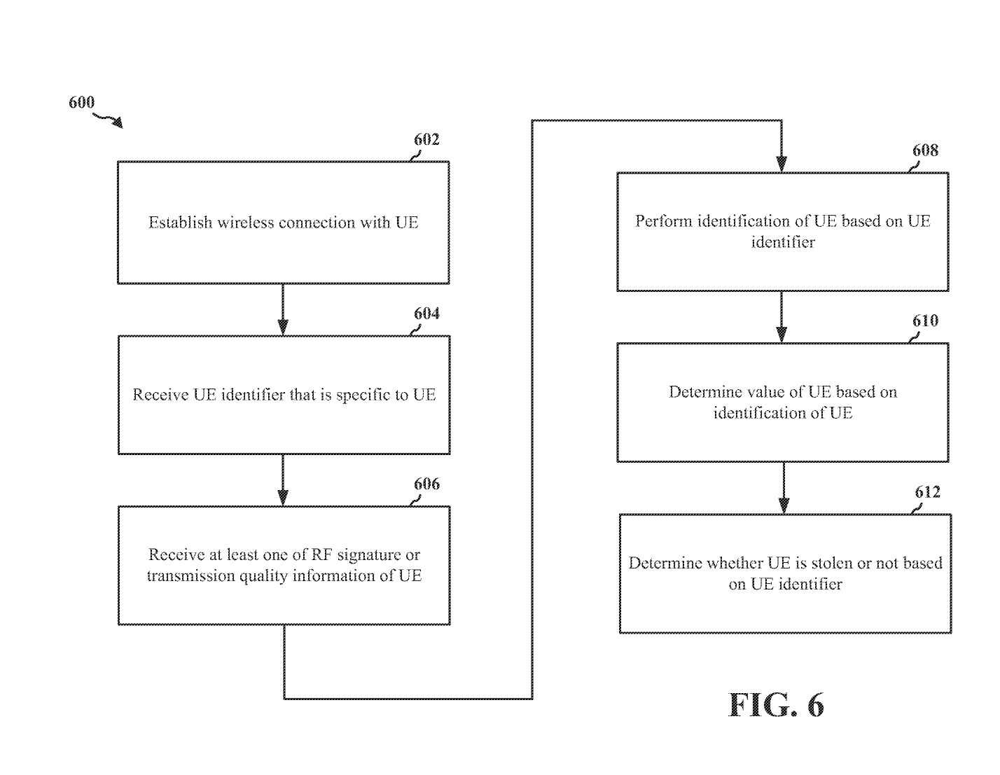

FIG. 6 is a flow chart 600 of a method of wireless communication. The method may be performed by a base station (e.g., the base station 310, the base station 520, the apparatus 702/702′) without connection to a core network. At 602, the base station establishes a wireless connection with a UE. In an aspect, the base station establishes the wireless connection with the UE by receiving a request to connect from the UE, and establishing the wireless connection with the UE based on the received request. In such an aspect, the request may be an emergency call. At 604, the base station receives a UE identifier that is specific to the UE. In an aspect, the UE identifier is an IMEI. In an aspect, the UE identifier is received from the UE via a pull operation. In an aspect, the UE identifier is received from the UE via a push operation. At 606, the base station receives at least one of an RF signature or transmission quality information of the UE.

As discussed supra, for example, the base station of the service station may wirelessly communicate with the UE in order to receive information related to the UE, and the UE may communicate identification information of the UE and/or other information (e.g., an RF signature, transmission quality information of the UE, etc.) to the base station of the service station. As discussed supra, for example, the base station in the service station is not connected to a core network (e.g., the EPC 110), and thus may not provide a cellular service. As discussed supra, for example, the UE may actively send the identification information of the UE to the base station (e.g., via a push operation), or the base station may retrieve the identification information from the UE (e.g., via a pull operation). As discussed supra, for example, upon receiving the connection request from the UE, the base station may establish connection with the UE based on the connection request. As discussed supra, for example, the user may use the emergency call features of the UE to establish connection between the UE and the base station, and the base station may receive the identification information of the UE through the established connection.

At 608, the base station performs identification of the UE based on the UE identifier. At 610, the base station determines a value of the UE based on the identification of the UE. At 612, the base station determines whether the UE is stolen or not based on the UE identifier. In an aspect, the base station is included in a service equipment. As discussed supra, for example, the base station of the service station may determine a type of the UE based on the identification information of the UE. As discussed supra, for example, after determining the type of the UE, the base station may further determine the value of the UE based the type of the UE. As discussed supra, for example, the base station at the service station may determine whether the UE is stolen or not, based on the identification information (e.g., IMEI) of the UE.

In an aspect, the base station includes a communication module to process a call processing message received from the UE. For example, as discussed supra, The communication module of the base station 520 may receive a call processing message (e.g., a telephone call) from the UE 530 and process the call processing message. In another aspect, the base station is connected to a central network element located outside the base station and is configured to forward a call processing message from the UE to the central network, where the central network element processes the call processing message forwarded by the base station. For example, as discussed supra, the base station 520 may be connected with a central network element that exists outside the service station 510, such that the central network element may process communication between the base station 520 and the UE 530. For example, as discussed supra, when the UE 530 sends a communication (e.g., an emergency call or a registration message) to the base station 520, the base station 520 forwards the communication to the central network element, and the central network element processes the communication from the UE 530.

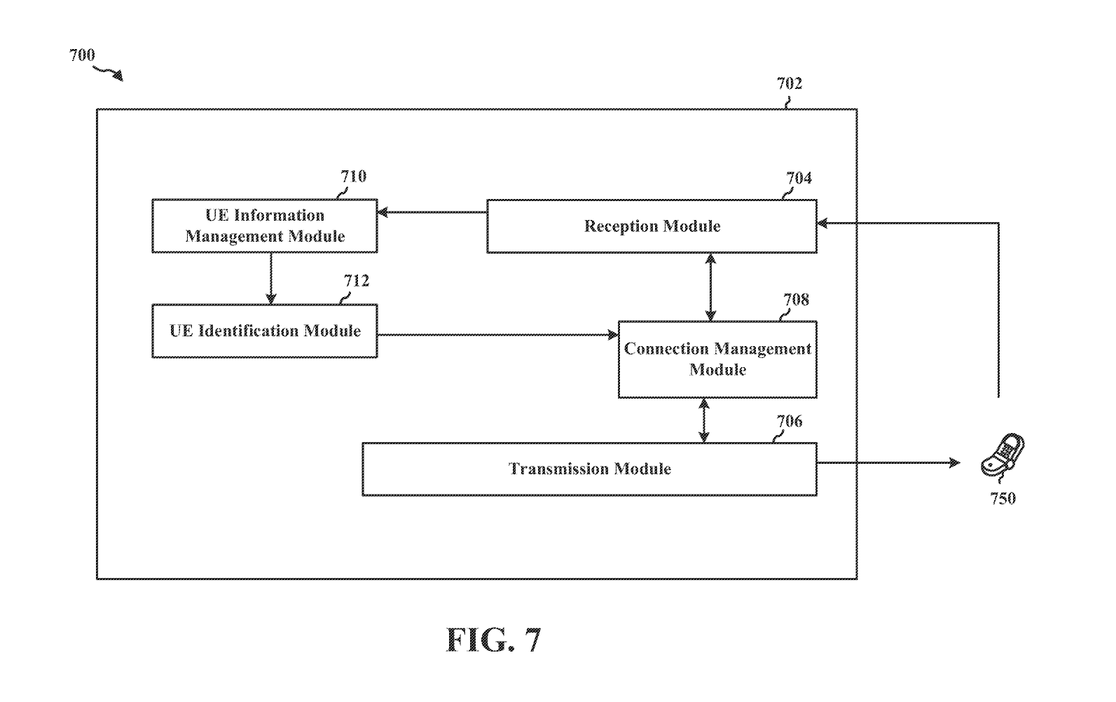

FIG. 7 is a conceptual data flow diagram 700 illustrating the data flow between different modules/means/components in an exemplary apparatus 702. The apparatus may be a base station without connection to a core network. The apparatus includes a reception module 704, a transmission module 706, a connection management module 708, a UE information management module 710, and a UE identification module 712.

The connection management module 708 establishes a wireless connection with a UE 750 via the reception module 704 and the transmission module 706, where the reception module 704 is configured to receive data from the UE 750 and the transmission module 706 is configured to send data to the UE 750. In an aspect, the connection management module 708 establishes the wireless connection with the UE 750 by receiving via the reception module 704 a request to connect from the UE 750, and establishing via the transmission module 706 and the reception module 704 the wireless connection with the UE 750 based on the received request. In such an aspect, the request may be an emergency call. The UE information management module 710 receives via the reception module 704 a UE identifier that is specific to the UE 750. In an aspect, the UE identifier is an IMEI. In an aspect, the UE identifier is received from the UE 750 via a pull operation. In an aspect, the UE identifier is received from the UE 750 via a push operation. The UE information management module 710 receives via the reception module 704 at least one of an RF signature or transmission quality information of the UE 750. The UE identification module 712 performs identification of the UE 750 based on the UE identifier. The UE identification module 712 determines a value of the UE based on the identification of the UE. The UE identification module 712 determines whether the UE is stolen or not based on the UE identifier. In an aspect, the apparatus 702 is included in a service equipment. In an aspect, the apparatus 702 includes a communication module to process a call processing message received from the UE. In another aspect, the apparatus 702 is connected to a central network element located outside the apparatus 702 and is configured to forward a call processing message from the UE to the central network, where the central network element processes the call processing message forwarded by the apparatus 702.

The apparatus may include additional modules that perform each of the steps of the algorithm in the aforementioned flow charts of FIG. 6. As such, each step in the aforementioned flow charts of FIG. 6 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

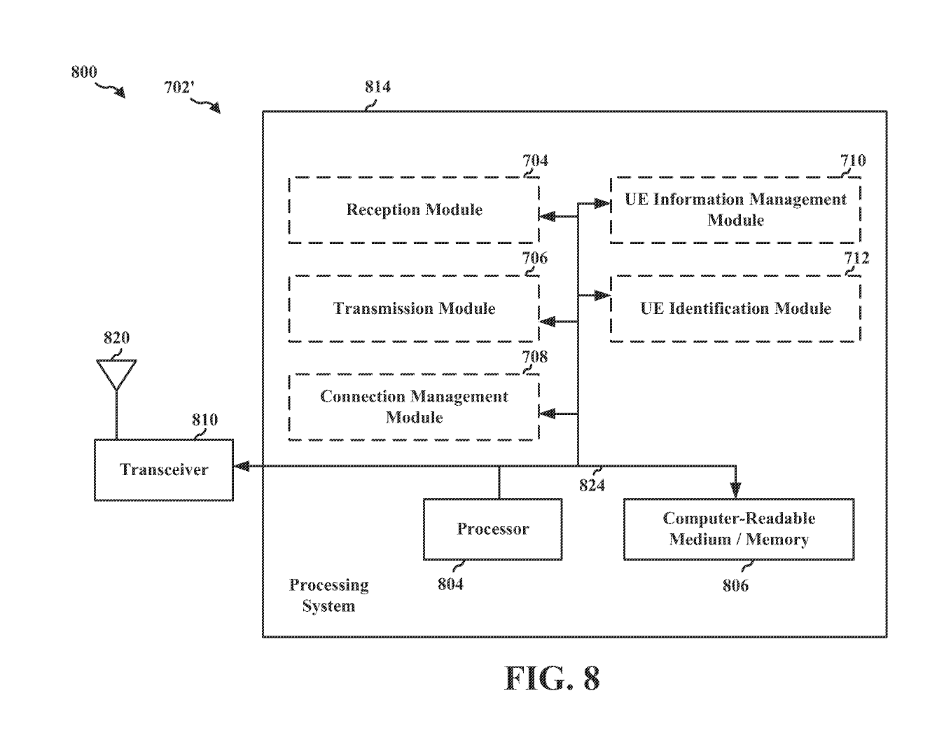

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 804, the modules 704, 706, 708, 710, 712, and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception module 704. In addition, the transceiver 810 receives information from the processing system 814, specifically the transmission module 706, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system further includes at least one of the modules 704, 706, 708, 710, and 712. The modules may be software modules running in the processor 804, resident/stored in the computer readable medium/memory 806, one or more hardware modules coupled to the processor 804, or some combination thereof. The processing system 814 may be a component of the base station 310 without connection to a core network and may include the memory 376 and/or at least one of the TX processor 316, the RX processor 370, and the controller/processor 375.

In one configuration, the apparatus 702/702′ without connection to a core network includes means for establishing a wireless connection with a UE, and means for receiving a UE identifier that is specific to the UE. The apparatus 702/702′ may include means for receiving at least one of an RF signature or transmission quality information of the UE. The apparatus 702/702′ may include means for performing identification of the UE based on the UE identifier and means for determining a value of the UE based on the identification of the UE. The apparatus 702/702′ may include means for determining whether the UE is stolen or not based on the UE identifier. The aforementioned means may be one or more of the aforementioned modules of the apparatus 702 and/or the processing system 814 of the apparatus 702′ configured to perform the functions recited by the aforementioned means. As described supra, the processing system 814 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of steps in the processes / flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, wherein the method is performed by a base station without connection to a core network, the method comprising:
establishing a wireless connection with a user equipment (UE); and
receiving a UE identifier that is specific to the UE.

2. The method of claim 1, wherein the UE identifier is an international mobile equipment identity (IMEI).

3. The method of claim 1, wherein the UE identifier is received from the UE via a pull operation.

4. The method of claim 1, wherein the UE identifier is received from the UE via a push operation.

5. The method of claim 1, further comprising:
receiving at least one of a radio-frequency (RF) signature or transmission quality information of the UE.

6. The method of claim 1, wherein the establishing the wireless connection with the UE comprises:
receiving a request to connect from the UE; and
establishing the wireless connection with the UE based on the received request.

7. The method of claim 6, wherein the request is an emergency call.

8. The method of claim 1, further comprising:
performing identification of the UE based on the UE identifier.

9. The method of claim 8, further comprising:
determining a value of the UE based on the identification of the UE.

10. The method of claim 1, further comprising:
determining whether the UE is stolen or not based on the UE identifier.

11. The method of claim 1, wherein the base station is included in a service equipment.

12. The method of claim 1, wherein the base station includes a communication module to process a call processing message received from the UE.

13. The method of claim 1, wherein the base station is connected to a central network element located outside the base station and is configured to forward a call processing message from the UE to the central network, and
wherein the central network element processes the call processing message forwarded by the base station.

14. A base station without connection to a core network, comprising:
means for establishing a wireless connection with a user equipment (UE); and
means for receiving a UE identifier that is specific to the UE.

15. The base station of claim 14, wherein the UE identifier is an international mobile equipment identity (IMEI).

16. The base station of claim 14, wherein the UE identifier is received from the UE via a pull operation.

17. The base station of claim 14, wherein the UE identifier is received from the UE via a push operation.

18. The base station of claim 14, further comprising:
means for receiving at least one of a radio-frequency (RF) signature or transmission quality information of the UE.

19. The base station of claim 14, wherein the means for establishing the wireless connection with the UE is configured to:
receive a request to connect from the UE; and
establish the wireless connection with the UE based on the received request.

20. The base station of claim 19, wherein the request is an emergency call.

21. The base station of claim 14, further comprising:
means for performing identification of the UE based on the UE identifier.

22. The base station of claim 21, further comprising:
means for determining a value of the UE based on the identification of the UE.

23. The base station of claim 14, further comprising:
means for determining whether the UE is stolen or not based on the UE identifier.

24. The base station of claim 14, wherein the base station is included in a service equipment.

25. The base station of claim 14, wherein the base station includes a communication module to process a call processing message received from the UE.

26. The base station of claim 14, wherein the base station is connected to a central network element located outside the base station and is configured to forward a call processing message from the UE to the central network, and
wherein the central network element processes the call processing message forwarded by the base station.

27. A base station without connection to a core network, comprising:
a memory; and
at least one processor coupled to the memory and configured to:
establish a wireless connection with a user equipment (UE); and
receive a UE identifier that is specific to the UE.

28. The base station of claim 27, wherein the UE identifier is an international mobile equipment identity (IMEI).

29. The base station of claim 27, wherein the at least one processor is further configured to:
receive at least one of a radio-frequency (RF) signature or transmission quality information of the UE.

30. A computer program product stored on a computer-readable medium for a base station without connection to a core network and comprising code that when executed on at least one processor causes the at least one processor to:
establish a wireless connection with a user equipment (UE); and
receive a UE identifier that is specific to the UE.
